(19) United States
(12) Patent Application Publication
(10) Pub. No.: US 2025/0069258 A1
(43) Pub. Date: Feb. 27, 2025

(54) IMAGE PROCESSING APPARATUS

(71) Applicant: SUBARU CORPORATION, Tokyo (JP)

(72) Inventors: Takumi FUNABASHI, Tokyo (JP); Yuichiroh TAMURA, Tokyo (JP); Atsuki MUNAKATA, Tokyo (JP)

(21) Appl. No.: 18/771,112

(22) Filed: Jul. 12, 2024

(30) Foreign Application Priority Data
Aug. 24, 2023 (JP) 2023-136170

(51) Int. Cl. G06T 7/73; G06T 7/593; G06V 20/56

(52) U.S. Cl. CPC G06T 7/73; G06T 7/593; G06V 20/588; G06T 2207/10012; G06T 2207/20081; G06T 2207/30244; G06T 2207/30256

(57) ABSTRACT

An image processing apparatus includes an estimation circuit and a correction circuit. The estimation circuit is configured to estimate, based on captured image data including an image of a lane line that defines a traveling road, a position of the lane line on a road surface of the traveling road. The correction circuit is configured to correct, based on a height position of an imager that has generated the captured image data with respect to the road surface of the traveling road, the position of the lane line on the road surface of the traveling road estimated by the estimation circuit.

### CROSS-REFERENCE TO RELATED APPLICATIONS

The present application claims priority from Japanese Patent Application No. 2023-136170 filed on Aug. 24, 2023, the entire contents of which are hereby incorporated by reference.

### BACKGROUND

The disclosure relates to an image processing apparatus that recognizes a traveling road, based on a captured image.

In a vehicle, a traveling road on which the vehicle travels is often recognized based on a captured image. For example, Japanese Unexamined Patent Application Publication No. H09-319872 discloses a technique that detects a lane line that defines a traveling road, based on a captured image.

### SUMMARY

An aspect of the disclosure provides an image processing apparatus including an estimation circuit and a correction circuit. The estimation circuit is configured to estimate, based on captured image data including an image of a lane line that defines a traveling road, a position of the lane line on a road surface of the traveling road. The correction circuit is configured to correct, based on a height position of an imager that has generated the captured image data with respect to the road surface of the traveling road, the position of the lane line on the road surface of the traveling road estimated by the estimation circuit.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is an explanatory diagram illustrating a configuration example of a traveling road recognition apparatus according to one example embodiment of the disclosure.

FIG. 2 is a block diagram illustrating a configuration example of the traveling road recognition apparatus illustrated in FIG. 1.

FIG. 3A is an explanatory diagram illustrating an example of a captured image.

FIG. 3B is an explanatory diagram illustrating another example of a captured image.

FIG. 4 is a block diagram illustrating a configuration example of a lane line detector illustrated in FIG. 2.

FIG. 5 is a flowchart illustrating an operation example of the lane line detector illustrated in FIG. 4.

FIG. 6 is an explanatory diagram illustrating an operation example of a height position detector illustrated in FIG. 4.

FIG. 7 is another explanatory diagram illustrating an operation example of the height position detector illustrated in FIG. 4.

FIG. 8 is an explanatory diagram illustrating an operation example of a lane line inferrer illustrated in FIG. 4.

FIG. 9 is an explanatory diagram illustrating an operation example of a lane line corrector illustrated in FIG. 4.

FIG. 10 is a block diagram illustrating a configuration example of a lane line detector according to a reference example.

FIG. 11 is a block diagram illustrating a configuration example of a traveling road recognition apparatus according to a modification example.

FIG. 12 is a block diagram illustrating a configuration example of a lane line detector according to another modification example.

FIG. 13 is a flowchart illustrating an operation example of the lane line detector illustrated in FIG. 12.

### DETAILED DESCRIPTION

In an image processing apparatus to be mounted on a vehicle, it is desired to accurately recognize a traveling road, and it is expected that the traveling road is recognized with high accuracy.

It is desirable to provide an image processing apparatus that makes it possible to improve accuracy in recognizing a traveling road.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### EXAMPLE EMBODIMENT

### Configuration Example

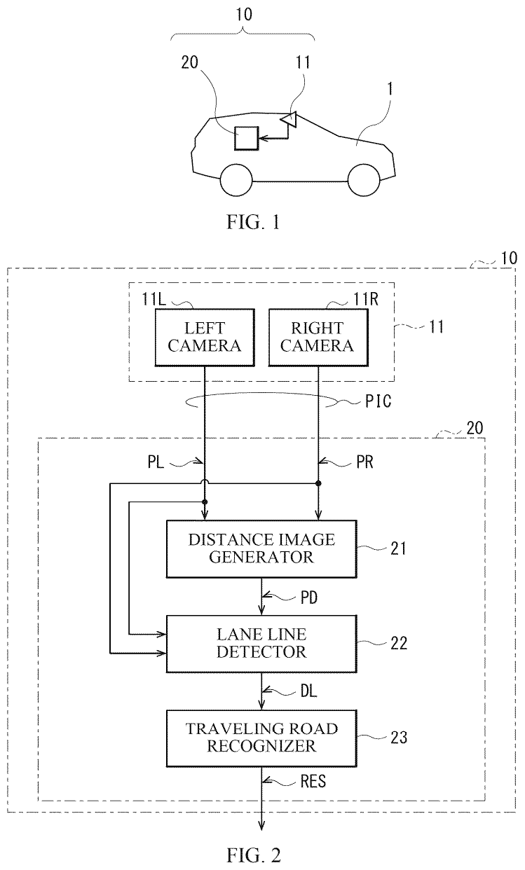

FIGS. 1 and 2 illustrate a configuration example of a traveling road recognition apparatus 10 including an image processing apparatus 20 according to an example embodiment. In this example, the traveling road recognition apparatus 10 may be mounted on a vehicle 1. The vehicle 1 may be any vehicle such as an automobile. The traveling road recognition apparatus 10 may be configured to recognize a traveling road on which the vehicle 1 travels. The traveling road recognition apparatus 10 may include a stereo camera 11 and the image processing apparatus 20.

The stereo camera 11 may be configured to generate a set of image data including left image data PL and right image data PR having a parallax between each other by capturing images ahead of the vehicle 1. The stereo camera 11 may include a left camera 11L and a right camera 11R. Each of the left camera 11L and the right camera 11R may include a lens and an image sensor. In this example, the left camera 11L and the right camera 11R may be disposed in the vehicle 1 in the vicinity of an upper part of a windshield of the vehicle 1 and spaced apart from each other by a predetermined distance in a width direction of the vehicle 1. The left camera 11L may generate the left image data PL, and the right camera 11R may generate the right image data PR. The left image data PL and the right image data PR may constitute stereo image data PIC. The stereo camera 11 may be configured to perform an imaging operation at a predetermined frame rate (for example, 60 [fps]) to generate a series of stereo image data PIC, and supply the generated stereo image data PIC to the image processing apparatus 20.

The image processing apparatus 20 may be configured to recognize the traveling road on which the vehicle 1 travels, based on the stereo image data PIC supplied from the stereo camera 11. In the vehicle 1, for example, based on data on the traveling road recognized by the image processing apparatus 20, it is possible to, for example, cause a travel control of the vehicle 1 to be performed or information on the recognized traveling road to be displayed on a console monitor. The image processing apparatus 20 may include, for example, a central processing unit (CPU) that executes a program, a random-access memory (RAM) that temporarily stores processing data, and a read-only memory (ROM) that stores the program. The image processing apparatus 20 may include a distance image generator 21, a lane line detector 22, and a traveling road recognizer 23.

The distance image generator 21 may be configured to generate distance image data PD by performing predetermined image processing including a stereo matching process, based on the left image data PL and the right image data PR. A pixel value of the distance image data PD may indicate a distance from the stereo camera 11 to a subject in a three-dimensional real space. The distance image generator 21 may be configured to obtain a parallax by performing the stereo matching process to detect corresponding points including image points in a left image related to the left image data PL and image points in a right image related to the right image data PR corresponding to each other, and calculate the distance to the subject, based on the parallax.

The lane line detector 22 may be configured to detect a lane line that defines the traveling road on which the vehicle 1 travels, based on the left image data PL, the right image data PR, and the distance image data PD. By detecting the lane line as described above, the lane line detector 22 may be configured to generate lane line data DL indicating a position of the lane line on a road surface of the traveling road.

In this example, the lane line detector 22 may infer the position of the lane line using a machine learning technique, based on a captured image obtained by the stereo camera 11. Thereafter, the lane line detector 22 may generate the lane line data DL by correcting the position of the inferred lane line, based on a height position of the stereo camera 11 with respect to the road surface of the traveling road. For example, a height from the road surface of the traveling road to the stereo camera 11 can vary depending on factors such as a type of the vehicle 1, the number of occupants, and an amount of load of cargo. Further, the height up to the stereo camera 11 can change, for example, when a vehicle height decreases due to aging deterioration of suspension. Because an image of the lane line in the captured image can vary depending on the height from the road surface of the traveling road to the stereo camera 11 as described below, the lane line detector 22 may correct the position of the inferred lane line, based on the height position of the stereo camera 11.

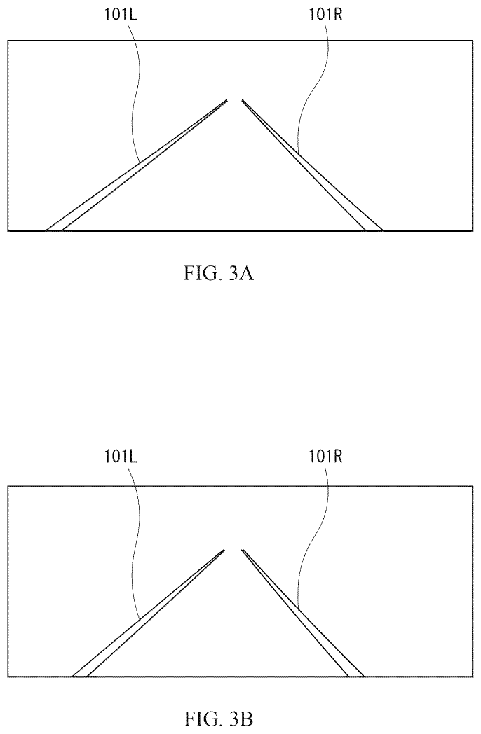

FIGS. 3A and 3B illustrate examples of the captured images taken by the stereo camera 11. FIG. 3A illustrates a case where the height position of the stereo camera 11 is low, and FIG. 3B illustrates a case where the height position of the stereo camera 11 is higher than that in FIG. 3A. For example, as illustrated in FIGS. 3A and 3B, when the height position of the stereo camera 11 is high (FIG. 3B), a distance between an image part of a left lane line 101L and an image part of a right lane line 101R in the captured image may be narrower than that when the height position of the stereo camera 11 is low (FIG. 3A). As described above, for example, even if an actual distance between two lane lines is the same, the distance between the image part of the left lane line 101L and the image part of the right lane line 101R in the captured image can vary depending on the height position of the stereo camera 11. Consequently, in this case, there is a possibility that accuracy in detecting the position of the lane line is lowered.

In contrast, the lane line detector 22 may infer the position of the lane line on the road surface of the traveling road, based on the captured image, and correct the position of the inferred lane line, based on the height position of the stereo camera 11. This makes it possible for the lane line detector 22 to improve the accuracy in detecting the position of the lane line.

FIG. 4 illustrates a configuration example of the lane line detector 22. The lane line detector 22 may include a height position detector 31, a lane line inferrer 32, a correction coefficient calculator 33, and a lane line corrector 34.

The height position detector 31 may be configured to detect the height position of the stereo camera 11 with respect to the road surface of the traveling road, based on the left image data PL, the right image data PR, and the distance image data PD.

The lane line inferrer 32 may be configured to infer the position of the lane line on the road surface of the traveling road using a machine learning model M stored in a storage 35, based on the left image data PL and the right image data PR. The machine learning model M may be, for example, a machine learning model of a deep neural network. The machine learning model M may be configured to receive image data and output the position of the lane line on the road surface of the traveling road. The machine learning model M may be generated by, for example, a machine learning apparatus performing a machine learning process, and may be stored in the storage 35 in advance. The machine learning apparatus may include a personal computer or any device having capability to execute machine learning. In addition to the machine learning model M, the storage 35 may also store reference data REF indicating the height position of a stereo camera that has generated the image data used in generating the machine learning model M.

The correction coefficient calculator 33 may be configured to generate a correction coefficient, based on the height position of the stereo camera 11 detected by the height position detector 31 and the height position indicated by the reference data REF stored in the storage 35.

The lane line corrector 34 may be configured to generate the lane line data DL indicating the position of the lane line on the road surface of the traveling road by correcting the position of the lane line inferred by the lane line inferrer 32 using the correction coefficient generated by the correction coefficient calculator 33.

The storage 35 may include, for example, a non-volatile memory, and may be configured to store the machine learning model M and the reference data REF.

With this configuration, the lane line detector 22 (FIG. 2) may be configured to generate the lane line data DL by inferring the position of the lane line, based on the captured image, and correcting the position of the inferred lane line, based on the height position of the stereo camera 11.

The traveling road recognizer 23 may be configured to generate a recognition result RES by recognizing the traveling road on which the vehicle 1 travels, based on the lane line data DL generated by the lane line detector 22. For example, the traveling road recognizer 23 may be configured to recognize a shape of the traveling road ahead of the vehicle 1, a curvature of the traveling road, or such features, and output the result as the recognition result RES.

In one embodiment, the image processing apparatus 20 may serve as an “image processing apparatus”. In one embodiment, the lane lines 101L and 101R may serve as a “lane line”. In one embodiment, the left image data PL and the right image data PR may serve as “captured image data”. In one embodiment, the lane line inferrer 32 may serve as an “estimation circuit”. In one embodiment, the stereo camera 11 may serve as an “imager”. In one embodiment, the lane line corrector 34 may serve as a “correction circuit”. In one embodiment, the height position detector 31 may serve as a “height position detection circuit”. In one embodiment, the correction coefficient calculator 33 may serve as a “correction coefficient calculation circuit”. In one embodiment, the machine learning model M may serve as a “machine learning model”. In one embodiment, the distance image data PD may serve as “distance image data”.

### [Operations and Workings]

Operations and workings of the traveling road recognition apparatus 10 according to the example embodiment will now be described.

### <Overview of Overall Operation>

First, with reference to FIGS. 1 to 4, an overview of an overall operation of the traveling road recognition apparatus 10 will be described.

The stereo camera 11 may generate a set of image data including the left image data PL and the right image data PR having a parallax between each other by capturing images ahead of the vehicle 1. The distance image generator 21 of the image processing apparatus 20 may generate the distance image data PD by performing the predetermined image processing including the stereo matching process, based on the left image data PL and the right image data PR. The lane line detector 22 may generate the lane line data DL indicating the position of the lane line on the road surface of the traveling road by detecting the lane line that defines the traveling road on which the vehicle 1 travels, based on the left image data PL, the right image data PR, and the distance image data PD. The traveling road recognizer 23 may generate the recognition result RES by recognizing the traveling road on which the vehicle 1 travels, based on the lane line data DL generated by the lane line detector 22.

### <Details of Operation>

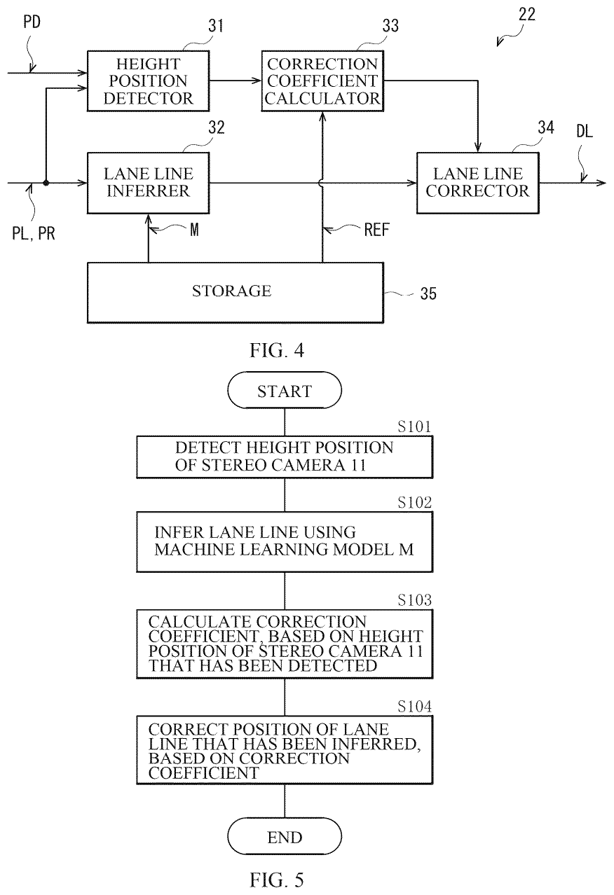

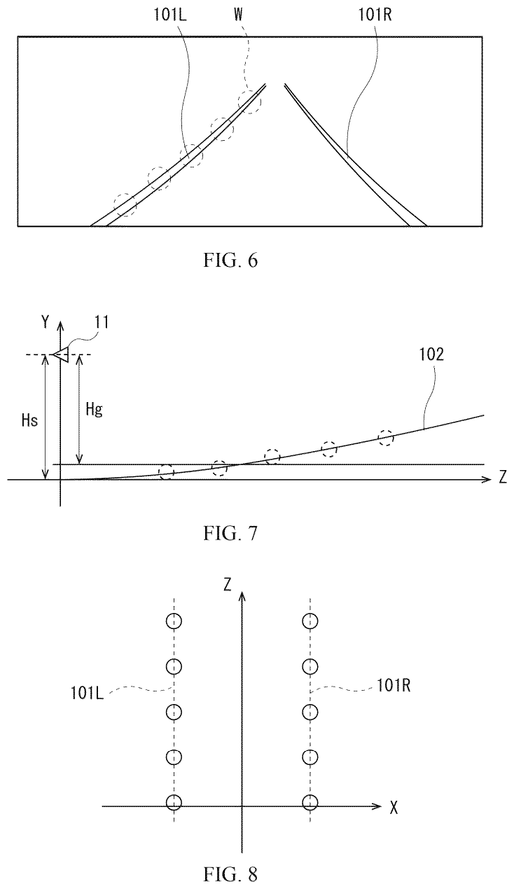

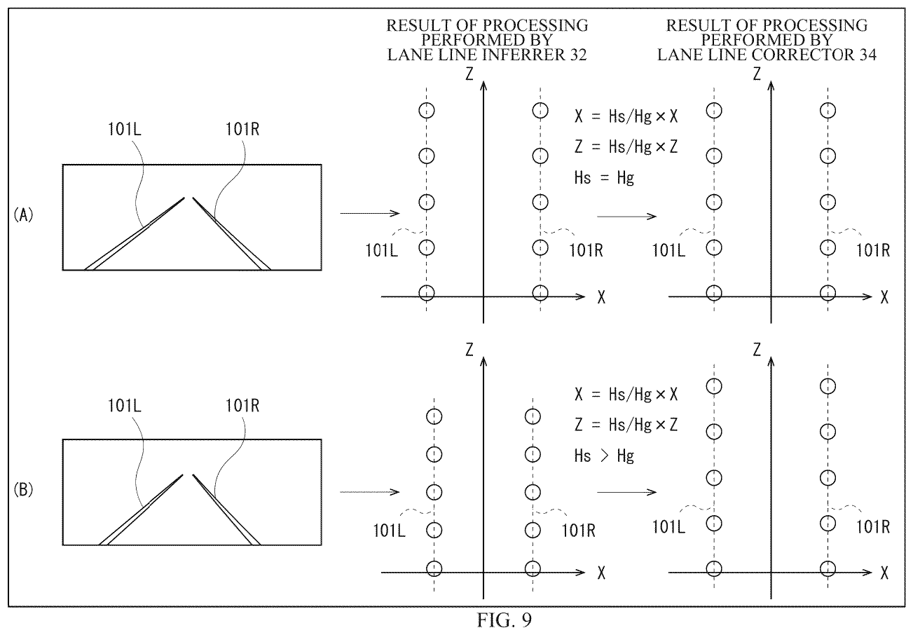

FIG. 5 illustrates an operation example of the lane line detector 22.

First, the height position detector 31 of the lane line detector 22 may detect the height position of the stereo camera 11 with respect to the road surface of the traveling road, based on the left image data PL, the right image data PR, and the distance image data PD (step S101). In this example, the height position detector 31 may detect the height position of the stereo camera 11, based on one of the left image data PL or the right image data PR and the distance image data PD.

FIG. 6 illustrates an example of the image data to be inputted to the height position detector 31. The image data may be one of the left image data PL or the right image data PR. The image of the image data may include the image part of the left lane line 101L and the image part of the right lane line 101R. As illustrated in FIG. 6, the distance image data PD may include, for example, distance values at multiple feature points on the road surface. The feature points may include five feature points W in this example.

FIG. 7 illustrates an operation example of the height position detector 31. In FIG. 7, a Z-axis may indicate a length direction of the vehicle 1, and a Y-axis may indicate a height direction of the vehicle 1. The height position detector 31 may plot coordinates of the feature points on the road surface on a YZ plane, and calculate an approximate curve 102 using, for example, a quadratic function. The approximate curve 102 may be a curve indicating the road surface ahead of the vehicle 1. In the example illustrated in FIG. 7, the traveling road may be slightly uphill. The height position detector 31 may calculate the height position of the stereo camera 11 by extrapolating the approximate curve 102 until the approximate curve 102 comes under the stereo camera 11. For example, the height position detector 31 may calculate the height position of the stereo camera 11, based on each of pieces of image data of images captured at different points in time from each other, and use an average value of the height positions as a height position Hs of the stereo camera 11. In other words, when the vehicle 1 is traveling, the calculated value of the height position can vary due to, for example, irregularities on the road surface. Because the height position can vary, the height position detector 31 may calculate the height position Hs of the stereo camera 11 by calculating the average value of the height positions.

Note that a height position Hg illustrated in FIG. 7 may be a height position indicated by the reference data REF. In other words, the height position Hg may be the height position of the stereo camera in the vehicle that has generated the image data used in generating the machine learning model M. In the image data used in generating the machine learning model M, the traveling road may be, in this example, horizontal. In this example, the height position Hs may be higher than the height position Hg in the vehicle that has generated the image data used in generating the machine learning model M. In other words, for example, the height of the vehicle 1 may be higher than the height of the vehicle that has generated the image data used in generating the machine learning model M.

Thereafter, the lane line inferrer 32 of the lane line detector 22 may infer the position of the lane line on the road surface of the traveling road using the machine learning model M, based on the left image data PL and the right image data PR (step S102). In this example, the lane line inferrer 32 may infer the position of the lane line using the machine learning model M, based on one of the left image data PL or the right image data PR.

FIG. 8 illustrates an operation example of the lane line inferrer 32. The lane line inferrer 32 may infer the position of the lane line as illustrated in FIG. 8, for example, based on the image data illustrated in FIG. 6. An X-axis may indicate a width direction of the vehicle 1, and a Z-axis may indicate the length direction of the vehicle 1. In FIG. 8, multiple points may indicate the positions of the lane lines. In this example, five points on a left side may indicate the position of the lane line 101L, and five points on a right side may indicate the position of the lane line 101R. In this example, the lane line inferrer 32 may use multiple points to represent the position of the lane line; however, this example is a non-limiting example, and a line may be used to represent the position of the lane line.

Thereafter, the correction coefficient calculator 33 of the lane line detector 22 may calculate the correction coefficient, based on the height position of the stereo camera 11 detected by the height position detector 31 and the height position indicated by the reference data REF (step S103). In this example, the correction coefficient may be Hs/Hg. Here, Hs may be the height position detected in step S101, and Hg may be the height position indicated by the reference data REF.

Thereafter, the lane line corrector 34 of the lane line detector 22 may correct the position of the lane line that has been inferred in step S102, based on the correction coefficient obtained in step S103 (step S104).

FIG. 9 illustrates an operation example of the lane line corrector 34. (A) illustrates an operation example of a case where the height position of the stereo camera 11 is low. (B) illustrates an operation example of a case where the height position of the stereo camera 11 is high. In this example, the height position Hs of the stereo camera 11 in the example of (A) may be the same as the height position Hg of the stereo camera in the vehicle that has generated the image data used in generating the machine learning model M.

As illustrated in FIG. 9, the lane line inferrer 32 may infer the position of the lane line on the road surface of the traveling road using the machine learning model M, for example, based on one of the left image data PL or the right image data PR (step S102). Because the height position of the stereo camera 11 is low in (A) of FIG. 9, and the height position of the stereo camera 11 is high in (B) of FIG. 9, results of processing performed by the lane line inferrer 32 may differ in the positions of the lane lines 101L and 101R. For example, compared with the case where the height position of the stereo camera 11 is low ((A) of FIG. 9), when the height position of the stereo camera 11 is high ((B) of FIG. 9), the intervals between the five points indicating the lane line 101L may be narrow, the intervals between the five points indicating the lane line 101R may be narrow, and the distance between the five points indicating the lane line 101L and the five points indicating the lane line 101R may be narrow.

Thereafter, the lane line corrector 34 may correct the position of the lane line inferred by the lane line inferrer 32, based on the correction coefficient (Hs/Hg) (step S104).

In the example illustrated in (A) of FIG. 9, the height position Hs of the stereo camera 11 detected by the height position detector 31 may be equal to the height position Hg indicated by the reference data REF (Hs=Hg). Consequently, as illustrated in (A) of FIG. 9, the result of processing performed by the lane line corrector 34 may be the same as the result of processing performed by the lane line inferrer 32.

In contrast, in the example illustrated in (B) of FIG. 9, the height position Hs of the stereo camera 11 detected by the height position detector 31 may be higher than the height position Hg indicated by the reference data REF (Hs>Hg). Consequently, as illustrated in (B) of FIG. 9, in the result of processing performed by the lane line corrector 34, the intervals between the five points indicating the lane line 101L may be widened, the intervals between the five points indicating the lane line 101R may be widened, and the distance between the five points indicating the lane line 101L and the five points indicating the lane line 101R may be increased.

As described above, in (B) of FIG. 9, because the height position Hs of the stereo camera 11 detected by the height position detector 31 differs from the height position Hg indicated by the reference data REF, the position of the lane line may be corrected in accordance with the difference in the height positions. As a result, as illustrated in (A) and (B) of FIG. 9, the result of the processing performed by the lane line corrector 34 in the case where the height position Hs of the stereo camera 11 is low ((A) of FIG. 9) and the result of the processing performed by the lane line corrector 34 in the case where the height position Hs of the stereo camera 11 is high ((B) of FIG. 9) may become substantially the same. In other words, it is possible for the lane line detector 22 to reduce influence of the height position of the stereo camera 11 on the position of the lane line.

This may be the end of this process.

As described above, in the lane line detector 22, the lane line corrector 34 corrects, based on the height position of the stereo camera 11, the position of the lane line inferred by the lane line inferrer 32. This makes it possible for the lane line detector 22 to facilitate the machine learning process as compared with a case of a reference example described below.

### Reference Example

A lane line detector 22R according to a reference example will now be described. In the reference example, data inputted to the machine learning model may be different from that in the example embodiment. For example, in the example embodiment, the image data may be inputted to the machine learning model, but instead, in the reference example, the image data and data of the height position of the stereo camera 11 may be inputted to the machine learning model. Other configurations may be similar to those of the example embodiment.

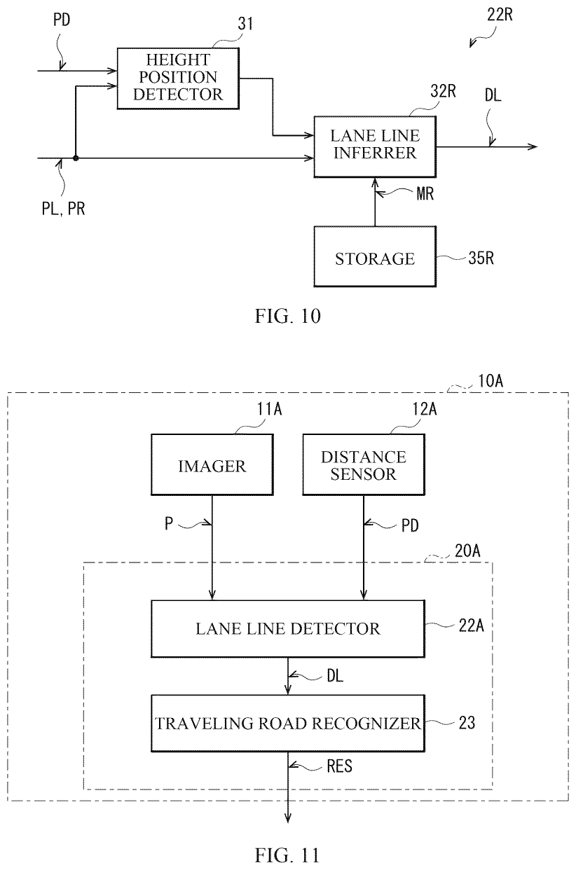

FIG. 10 illustrates a configuration example of the lane line detector 22R. The lane line detector 22R may include the height position detector 31, a lane line inferrer 32R, and a storage 35R.

The lane line inferrer 32R may be configured to infer the position of the lane line on the road surface of the traveling road using a machine learning model MR stored in the storage 35R, based on the left image data PL, the right image data PR, and the height position of the stereo camera 11 detected by the height position detector 31. The machine learning model MR may be configured to receive the image data and the data of the height position of the stereo camera 11, and to output the position of the lane line on the road surface of the traveling road. The machine learning model MR may be generated by, for example, a machine learning apparatus performing a machine learning process, and may be stored in the storage 35R in advance. The machine learning apparatus may include a personal computer or any device having capability to execute machine learning.

The storage 35R may include, for example, a non-volatile memory, and may be configured to store the machine learning model MR.

In the reference example, the image data and the data of the height position of the stereo camera 11 may be inputted to the machine learning model MR. Consequently, the machine learning process that generates the machine learning model MR may be performed using a data set including the image data and the data of the height position of the stereo camera 11. In other words, multiple data sets in which the height positions of the stereo camera 11 are different from each other may be to be prepared, and the machine learning process may be to be performed using the multiple data sets. Consequently, a large number of data sets may be to be used to perform the machine learning process, and furthermore, there is a possibility that the machine learning process takes time.

In contrast, in the lane line detector 22 according to the example embodiment, the image data may be inputted to the machine learning model M. Consequently, the machine learning process that generates the machine learning model M may be performed using a data set including the image data associated with one height position. In other words, it may save preparing multiple data sets with height positions different from each other. Further, because multiple data sets with height positions different from each other are not used, it is possible to shorten the time to be used by the machine learning process. This makes it possible to facilitate the machine learning process.

As described above, the image processing apparatus 20 includes the lane line inferrer 32 and the lane line corrector 34. The lane line inferrer 32 is configured to estimate, based on captured image data (the left image data PL and the right image data PR) including the image of the lane line that defines the traveling road, the position of the lane line on the road surface of the traveling road. The lane line corrector 34 is configured to correct, based on the height position of the stereo camera 11 that has generated the captured image data with respect to the road surface of the traveling road, the position of the lane line on the road surface of the traveling road estimated by the lane line inferrer 32. The configuration makes it possible, for example, to more accurately estimate the position of the lane line in various types of vehicles and more accurately estimate the position of the lane line even when the number of occupants of the vehicle 1 or the amount of load of the cargo changes. Further, for example, even when the vehicle height decreases due to aging deterioration of the suspension, it is possible to more accurately estimate the position of the lane line. As a result, it is possible for the image processing apparatus 20 to improve the accuracy in recognizing the traveling road.

In other words, for example, because the height of the vehicle varies depending on the type of the vehicle, the height position of the stereo camera 11 can vary depending on the type of the vehicle. Further, for example, when the amount of load on the vehicle 1 changes, the state of the suspension changes, which can change the height position of the stereo camera 11. For example, when the height position of the stereo camera 11 is low, the captured image may be like an image illustrated in FIG. 3A, and it can be determined that the distance between the lane lines is wide. Further, for example, when the height position of the stereo camera 11 is high, the captured image may be like an image illustrated in FIG. 3B, and it can be determined that the distance between the lane lines is narrow. This may possibly lower the accuracy in recognizing the traveling road.

In contrast, in the image processing apparatus 20, the position of the lane line estimated by the lane line inferrer 32 is corrected based on the height position of the stereo camera 11. This makes it possible to reduce influence of the height position of the stereo camera 11 on the position of the lane line as illustrated in FIG. 9. For example, the image processing apparatus 20 may correct the position of the lane line, based on the height position of the stereo camera 11 in the vehicle in various types of vehicles. Further, for example, the image processing apparatus 20 may correct the position of the lane line, based on the height position of the stereo camera 11 corresponding to factors such as the number of occupants and the amount of load of the cargo. As a result, it is possible for the image processing apparatus 20 to improve the accuracy in recognizing the traveling road.

In some embodiments, the image processing apparatus 20 may include the height position detector 31 configured to detect the height position of the stereo camera 11, based on the captured image data (the left image data PL and the right image data PR). The lane line corrector 34 may be configured to correct the position of the lane line, based on the height position of the stereo camera 11 detected by the height position detector 31. This makes it possible to correct the position of the lane line, based on the height position of the stereo camera 11 at a given time, for example, when the amount of load on the vehicle 1 is changed. Consequently, it is possible for the image processing apparatus 20 to improve the accuracy in recognizing the traveling road.

In some embodiments, the image processing apparatus 20 may further include the correction coefficient calculator 33 configured to calculate the correction coefficient. The lane line inferrer 32 may be configured to estimate, based on the captured image data (the left image data PL and the right image data PR), the position of the lane line using the machine learning model. The correction coefficient calculator 33 may be configured to calculate the correction coefficient, based on the height position of the stereo camera 11 and a reference height position. The correction coefficient calculator 33 may be configured to correct the position of the lane line, based on the correction coefficient. This makes it possible to facilitate the machine learning process as described in comparison with the reference example.

### Example Effects

As described above, the image processing apparatus according to the example embodiment includes the lane line inferrer and the lane line corrector. The lane line inferrer is configured to estimate, based on the captured image data including the image of the lane line that defines the traveling road, the position of the lane line on the road surface of the traveling road. The lane line corrector is configured to correct, based on the height position of the stereo camera that has generated the captured image data with respect to the road surface of the traveling road, the position of the lane line on the road surface of the traveling road estimated by the lane line inferrer. This helps to improve the accuracy in recognizing the traveling road.

In some embodiments, the image processing apparatus may include the height position detector configured to detect the height position of the stereo camera, based on the captured image data. The lane line corrector may be configured to correct the position of the lane line, based on the height position of the stereo camera detected by the height position detector. This helps to improve the accuracy in recognizing the traveling road.

In some embodiments, the image processing apparatus may further include the correction coefficient calculator configured to calculate the correction coefficient. The lane line inferrer may be configured to estimate, based on the captured image data, the position of the lane line using the machine learning model. The correction coefficient calculator may be configured to calculate the correction coefficient, based on the height position of the stereo camera and the reference height position. The correction coefficient calculator may be configured to correct the position of the lane line, based on the correction coefficient. This helps to facilitate the machine learning process.

### Modification Example 1

In the above-described example embodiment, the stereo camera 11 may be provided; however this example is a non-limiting example. In some embodiments, a monocular camera may be provided. Hereinafter, a traveling road recognition apparatus 10A according to a modification example 1 will be described in detail.

FIG. 11 illustrates a configuration example of the traveling road recognition apparatus 10A. The traveling road recognition apparatus 10A may include an imager 11A, a distance sensor 12A, and an image processing apparatus 20A.

The imager 11A may be a monocular camera, and may be configured to generate image data P by capturing an image ahead of the vehicle 1. The distance sensor 12A may be, for example, a light detection and ranging (LiDAR) sensor, and may be configured to generate the distance image data PD by detecting a distance to a subject.

The image processing apparatus 20A may be configured to recognize the traveling road on which the vehicle 1 travels, based on the image data P supplied from the imager 11A and the distance image data PD supplied from the distance sensor 12A. The image processing apparatus 20A may include a lane line detector 22A and the traveling road recognizer 23.

The lane line detector 22A may be configured to generate the lane line data DL indicating the position of the lane line on the road surface of the traveling road by detecting the lane line that defines the traveling road on which the vehicle 1 travels, based on the image data P and the distance image data PD. The lane line detector 22A may include a configuration that is similar to the lane line detector 22 (FIG. 4) according to the above-described example embodiment.

In one embodiment, the image processing apparatus 20A may serve as an “image processing apparatus”. In one embodiment, the image data P may serve as “captured image data”. In one embodiment, the imager 11A may serve as an “imager”. In one embodiment, the distance sensor 12A may serve as a “distance sensor”.

### Modification Example 2

In the above-described example embodiment, the height position detector 31 may be provided, however this example is a non-limiting example. In some embodiments, the height position detector 31 may be omitted. Hereinafter, a lane line detector 22B according to a modification example 2 will be described in detail.

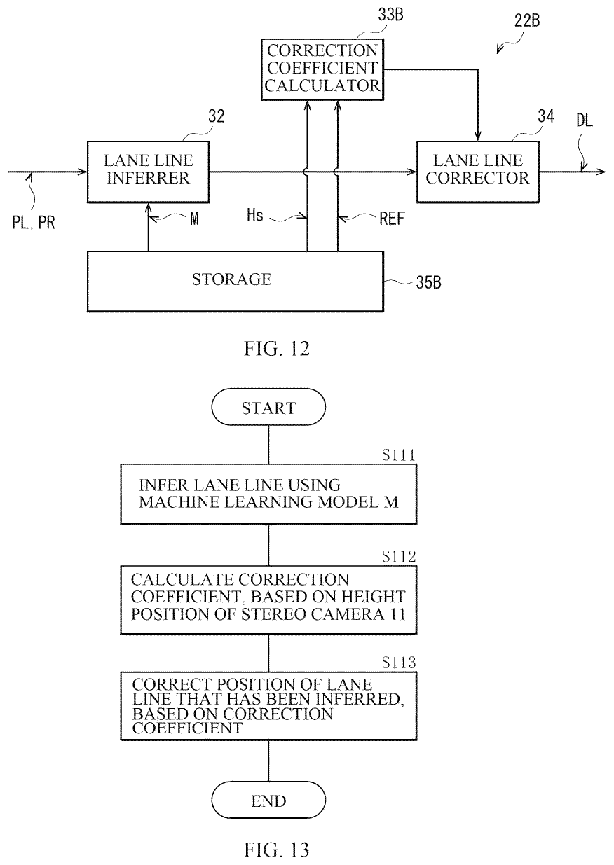

FIG. 12 illustrates a configuration example of the lane line detector 22B. The lane line detector 22B may include the lane line inferrer 32, a correction coefficient calculator 33B, the lane line corrector 34, and a storage 35B.

The correction coefficient calculator 33B may be configured to generate the correction coefficient, based on the data on the height position Hs of the stereo camera 11 stored in the storage 35B and the reference data REF stored in the storage 35B.

The storage 35B may be configured to store the machine learning model M, the data on the height position Hs of the stereo camera 11, and the reference data REF. The height position Hs may be set to, for example, a value corresponding to the type of the vehicle 1. In one embodiment, the storage 35B may serve as a “storage circuit”.

FIG. 13 illustrates an operation example of the lane line detector 22B.

First, the lane line inferrer 32 of the lane line detector 22B may infer the position of the lane line on the road surface of the traveling road using the machine learning model M, based on the left image data PL and the right image data PR (step S111). This operation may be similar to the operation of step S102 in the above-described example embodiment.

Thereafter, the correction coefficient calculator 33B of the lane line detector 22B may generate the correction coefficient, based on the height position Hs of the stereo camera 11 stored in the storage 35B (step S112). The correction coefficient may be Hs/Hg as in the case of the above-described example embodiment.

Thereafter, the lane line corrector 34 of the lane line detector 22B may correct the position of the lane line that has been inferred in step S111, based on the correction coefficient obtained in step S112 (step S113). This operation may be similar to the operation of step S104 in the above-described example embodiment.

This may be the end of this process.

Consequently, the lane line corrector 34 of the lane line detector 22B may correct the position of the lane line estimated by the lane line inferrer 32, based on the height position of the stereo camera 11. In this example, the height position of the stereo camera 11 may be a value corresponding to the type of the vehicle and may be stored in the storage 35B. This makes it possible for the lane line detector 22B to perform correction in accordance with the type of the vehicle 1.

Note that, in this example, the correction coefficient calculator 33B may be provided, and the correction coefficient calculator 33B may calculate the correction coefficient; however, this example is a non-limiting example. In some embodiments, the correction coefficient calculator 33B may be omitted. In this case, the storage 35B may store the correction coefficient, and the lane line corrector 34 may correct the position of the inferred lane line, based on the correction coefficient stored in the storage 35B.

### Other Modification Examples

Note that any two or more of these modification examples may be combined with each other.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the above-described example embodiment, the height position detector 31 may calculate the height position Hs of the stereo camera 11 using the approximate curve 102; however, this example is a non-limiting example. In some embodiments, the height position Hs of the stereo camera 11 may be calculated using other methods. For example, the height position detector 31 may detect the height position of the stereo camera 11 using the machine learning technique, for example, based on the left image data PL, the right image data PR, and the distance image data PD.

The example effects described herein are mere examples, and example effects of the disclosure are therefore not limited to those described herein, and other example effects may be achieved.

Furthermore, the disclosure may encompass at least the following embodiments.
(1) An image processing apparatus including:
   an estimation circuit configured to estimate, based on captured image data including an image of a lane line that defines a traveling road, a position of the lane line on a road surface of the traveling road, and
   a correction circuit configured to correct, based on a height position of an imager that has generated the captured image data with respect to the road surface of the traveling road, the position of the lane line on the road surface of the traveling road estimated by the estimation circuit.
(2) The image processing apparatus according to (1), further including a height position detection circuit configured to detect the height position of the imager, based on the captured image data, in which
   the correction circuit is configured to correct the position of the lane line, based on the height position of the imager detected by the height position detection circuit.
(3) The image processing apparatus according to (2), further including a correction coefficient calculation circuit configured to calculate a correction coefficient, in which
   the estimation circuit is configured to estimate, based on the captured image data, the position of the lane line using a machine learning model,
   the correction coefficient calculation circuit is configured to calculate the correction coefficient, based on the height position of the imager and a reference height position, and
   the correction circuit is configured to correct the position of the lane line, based on the correction coefficient.
(4) The image processing apparatus according to (2) or (3), in which
   the captured image data includes left image data and right image data, and
   the height position detection circuit is configured to estimate the height position of the imager, based on the captured image data and distance image data that corresponds to the captured image data.
(5) The image processing apparatus according to (2) or (3), in which the height position detection circuit is configured to estimate the height position of the imager, based on a result of detection by a distance sensor, the distance sensor being configured to detect a distance from the imager to a subject.
(6) The image processing apparatus according to (1), further including a storage circuit configured to store the height position of the imager, in which
   the correction circuit is configured to correct the position of the lane line, based on the height position of the imager stored in the storage circuit.

Each of the lane line inferrer 32 and the lane line corrector 34 illustrated in FIG. 4 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the lane line inferrer 32 and the lane line corrector 34. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the lane line inferrer 32 and the lane line corrector 34 illustrated in FIG. 4.

1. An image processing apparatus comprising:
an estimation circuit configured to estimate, based on captured image data comprising an image of a lane line that defines a traveling road, a position of the lane line on a road surface of the traveling road, and
a correction circuit configured to correct, based on a height position of an imager that has generated the captured image data with respect to the road surface of the traveling road, the position of the lane line on the road surface of the traveling road estimated by the estimation circuit.

2. The image processing apparatus according to claim 1, further comprising a height position detection circuit configured to detect the height position of the imager, based on the captured image data, wherein
the correction circuit is configured to correct the position of the lane line, based on the height position of the imager detected by the height position detection circuit.

3. The image processing apparatus according to claim 2, further comprising a correction coefficient calculation circuit configured to calculate a correction coefficient, wherein
the estimation circuit is configured to estimate, based on the captured image data, the position of the lane line using a machine learning model,
the correction coefficient calculation circuit is configured to calculate the correction coefficient, based on the height position of the imager and a reference height position, and
the correction circuit is configured to correct the position of the lane line, based on the correction coefficient.

4. The image processing apparatus according to claim 2, wherein
the captured image data comprises left image data and right image data, and
the height position detection circuit is configured to estimate the height position of the imager, based on the captured image data and distance image data that corresponds to the captured image data.

5. The image processing apparatus according to claim 2, wherein the height position detection circuit is configured to estimate the height position of the imager, based on a result of detection by a distance sensor, the distance sensor being configured to detect a distance from the imager to a subject.

6. The image processing apparatus according to claim 1, further comprising a storage circuit configured to store the height position of the imager, wherein
the correction circuit is configured to correct the position of the lane line, based on the height position of the imager stored in the storage circuit.
